(19) United States
(12) Patent Application Publication
(10) Pub. No.: US 2005/0044758 A1
(43) Pub. Date: Mar. 3, 2005

(54) More readily identifiable license plate

(76) Inventor: Gary P. Richard, Gloucester, MA (US)

Correspondence Address: Iandiorio & Teska, 260 Bear Hill Road, Waltham, MA, 02451-1018, US

(21) Appl. No.: 10/652,540

(22) Filed: Aug. 29, 2003

(51) Int. Cl. G09F 7/00

(52) U.S. Cl. 40/200

(57) ABSTRACT

A more readily identifiable license plate includes a face, a symbol occupying a large portion of the face so it can be recognized by a child, and a combination of a letter or letters and/or a number or numbers, wherein the symbol together with the combination of letters and/or numbers constitute a unique license plate number or code. A method for facilitating the apprehension of child abductors includes producing and registering vehicles with the more readily identifiable license plates each including a colored symbol as a part of the license plate number or code and teaching children to identify the symbol of the license plate first.

### FIELD OF THE INVENTION

This invention relates to a more readily identifiable license plate as a means to more easily identify the vehicle of a child abductor, other suspicious or criminal behavior, parties in an accident, poor drivers, as well as the general public identifying their own and other vehicles. It is also allows for expressions of interests, such as hobbies, sports, social programs, family activities, business related affiliations, and the like.

### BACKGROUND OF THE INVENTION

A typical license plate includes an alpha numeric code or license plate “number” which most people cannot easily remember. For example, the license plate number F81340 can be difficult for even an adult registrant to remember.

The reason, of course, for the use of many letters and/or numbers as the code is that each license plate must be distinctive: every vehicle owner in a given state must have a unique license plate number for authorities to properly track vehicles since the license plate itself is an attestation that a particular vehicle is properly registered.

But, distinctiveness comes with a price—namely, identifiability or ease of remembering. Especially in the case where a child is involved in a near or actual abduction, it can be difficult for the child or other children witnesses to remember a vehicle's license plate number. The same is true even for adults. In the case of a hit and run offense or the like, the license plate number F81340 can be difficult even for adult witnesses to remember accurately.

In this invention, the trade off between distinctiveness and identifiably is noted and a new more readily identifiable license plate which is sufficiently distinctive is featured primarily for children to assist in this nation's effort at combating child abductions.

### SUMMARY OF THE INVENTION

It is therefore an object of this invention to provide a more readily identifiable license plate.

It is a further object of this invention to provide such a license plate which is also distinctive and still capable of providing vehicle registrants in a given state with a unique license plate number or code.

It is a further object of this invention to employ the use of a symbol as an “active” part of the license plate code/number.

It is a further object of this invention to minimize the quantity of characters on the license plate making it easier to remember.

It is a further object of this invention to maximize the size of the characters making them more visible from longer distances.

It is a further object of this invention to incorporate self illuminating materials to aid in visibility in darkness.

It is a further object of this invention to provide an relative time line based on the strength of the self illumination resulting from how recently the license plate was “charged” by the individuals automotive running lights. By law, license plates need to be illuminated by more than just head and tail lights. The more recent the exposure to the running lights, the greater the glow of the self illuminating materials. This indicates to law enforcement how recently the vehicle had been driven.

It is a further object of this invention to use the self illuminating feature of the license plate as a light source to find an individual who had an accident and could be in a ditch, etc., away from the road's visibility without lights. This would aid in the rescue process, even if days went by. The illumination material lasts for hours and is recharged also by daylight.

It is a further object of this invention to benefit from the self illuminating license plate as additional lighting on streets where there may be no lighting to begin with, or allowing existing lighting be reduced due to the amount of illumination being generated by multiple vehicles. This could provide significant safety advantages as well as cost savings.

It is a further object of this invention to provide visibility to the driver and to other drivers should the vehicles lighting system fail, or forgot to be turned on while driving. The material gets charged from daylight to a visible level for night time, even without being charged from the vehicles running lights.

It is a further object of this invention to aid individuals to recall their own vehicle number for their own or law enforcement locating purposes. If you ask most individuals they cannot tell you their own license plate number. In a stressful situation it becomes even more difficult to remember. By having a distinctive license plate with fewer characters to remember, individuals have better recollection, especially being able to recall what symbol is on their plate.

It is a further object of this invention to give more recognizable information to an individual who is trying to ascertain a license plate number while viewing through a rear view mirror. Alphanumeric characters are very difficult to read when they are shown in reverse as seen as a reflection, especially while vehicles are moving. Symbols like a star are mirror images of themselves and therefore look the same face on or in reverse. Symbols such as a duck still look like a duck whether facing left or facing right.

It is a further object of this invention to employ the usage of colors as an active factor allowing for more available combinations using the same characters combinations.

It is a further object of this invention to provide law enforcement and registry personnel with administrative information for more expeditious reporting purposes. The codes in the middle zone of the license plate contains information on the color, symbol description, and location of the active symbol.

It is a further object of this invention to allow for individual expressions of social, business, or other interests to be reflected through the selection of the active symbols.

It is a further object of this invention to allow individuals to more easily recognize their own vehicle in parking lots occupying numerous similar looking vehicles.

It is a further object of this invention to raise much needed funding for social programs, etc., by offering symbol, number and color preferences, to the registrant for a fee.

It is a further object of this invention to aid in reporting vehicles involved in criminal behavior, suspected criminal behavior, or in accidents, bad driving and the like.

The invention results from the realization that by using relatively few readily identifiable symbols of different colors, the uniqueness of each license plate's code can be maintained and yet now even children can more easily identify a vehicle's license plate in order to apprehend suspected or actual child abductors.

This invention features a more readily identifiable license plate comprising a face, a symbol occupying a large portion of the face so it can be recognized by a child, and a combination of a letter or letters and/or a number or numbers, wherein the symbol together with the combination of letters and/or numbers constitute a unique license plate number or code.

Preferably, the symbol is in color and there is a cryptogram on the face of the license plate which indicates the color of the symbol and the type of symbol. In one example, the cryptogram indicates a mnemonic with letters abbreviating the type of symbol. Also, the cryptogram may indicate the position of the symbol.

Typically, the symbol is a geometric shape but may be any visual depiction of a person, animal, place, or thing. Or, the symbol could be a letter. In one embodiment, the symbol is representative of the region of registration of the license plate and the symbol could be chosen by the registrant.

Typically, the symbol is solid and occupies at least 15% of the face of the license plate. Preferably, the face includes an illumination material such as strontium aluminate.

In one embodiment, the face of the plate is divided into zones: a left zone, a middle zone, and a right zone. Typically, the symbol occupies the left zone or the right zone which may be subdivided into multiple positions. In one example, the symbol occupies a single position in a zone.

One more readily identifiable license plate in accordance with the subject invention includes a face, a colored symbol occupying a large portion of the face so it can be recognized by a child, and a cryptogram on the face of the license plate which indicates the type and color of the symbol.

A more readily identifiable license plate in accordance with this invention features a face, a symbol in color occupying a large portion of the face so that can be recognized by a child, a cryptogram on the face of a license plate which indicates the color of the symbol, the type of the symbol, and the position of the symbol, and a combination of a letter or letters and/or a number or numbers, wherein the symbol together with the combination of letters and/or numbers constitute a unique license plate number or code.

A more readily identifiable license plate in accordance with this invention features a face with an illumination material thereon, a symbol occupying a large portion of the face so that can be recognize by a child, and a combination of a letter or letters and/or a number or numbers, wherein the symbol together with a combination of letters and/or numbers constitute a unique license plate number or code.

A system for facilitating the apprehension of child abductors in accordance with this invention features a plurality of readily identifiable license plates including a symbol as a part of the license plate number or code and an educational component for teaching children how to identify the symbol of the license plate first and then the remainder of the license plate number or code. Typically, the educational component teaches children how to identify the location of the symbol on the plate, the color of the symbol, and the type of vehicle bearing the plate.

A method for facilitating the apprehension of child abductors in accordance with this invention features producing and registering vehicles with more readily identifiable license plates each including a colored symbol as a part of the license plate number or code and teaching children to identify the symbol of the license plate first. Typically, children are taught how to identify the location of the symbol on the plate, the color of the symbol, and the type of vehicle bearing the plate.

### BRIEF DESCRIPTION OF THE DRAWINGS

Other objects, features and advantages will occur to those skilled in the art from the following description of a preferred embodiment and the accompanying drawings, in which:

FIGS. 1A-1D are schematic depictions of typical prior license plates;

FIG. 2 is a schematic view of an example of a more readily identifiable license plate in accordance with the subject invention;

FIGS. 3D-3K are schematic depictions of additional examples of more readily identifiable license plates in accordance with the subject invention;

FIG. 4 is a table showing combinations of number and letter codes when using distinct colored symbols in accordance with the subject invention;

FIG. 5 is a schematic depiction showing how, in one example, a license plate can be identified into different zones in accordance with the subject invention;

FIG. 6 is a schematic depiction showing information provided in the middle zone of FIG. 5;

FIG. 7 is a schematic depiction showing which information can be included in the left and right zones of FIG. 5;

FIG. 8 is a schematic depiction showing how different zones can include different positions in accordance with the subject invention;

FIG. 9 is a schematic depiction showing the use of the different positions within the different zones in accordance with the subject invention; and

FIG. 10 is a schematic block diagram showing the use of the more readily identifiable license plate in accordance with the subject invention in combination with a license plate identification system and the Amber alert system.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings.

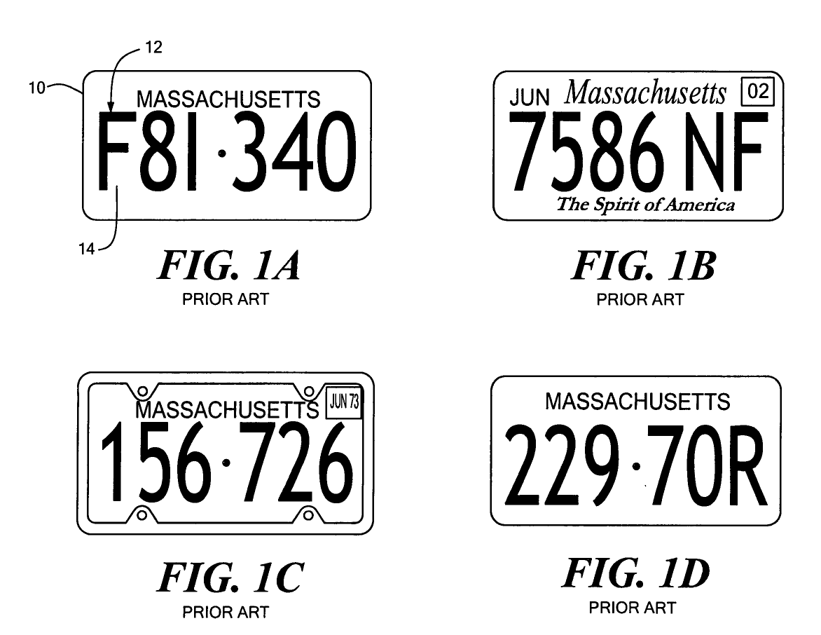

FIGS. 1A-1D show typical license plates 10 of the prior art including alphanumeric code 12 on face 14 as depicted in FIG. 1A in which the license plate “number” is F81340.

Imagine a group of five year-old children walking home from school or playing in a neighborhood, one of which is subject to a near or actual abduction by the occupant of a vehicle bearing license plate 10, FIG. 1A. In all likelihood, no child will remember anything about license plate 10. Perhaps one or more child witnesses will be able to tell the authorities that the vehicle involved was, for example, a black truck, but stopping and searching and/or questioning the occupants of all black trucks in a given area can run a foul of constitutional guarantees and, in any case, could be highly impractical.

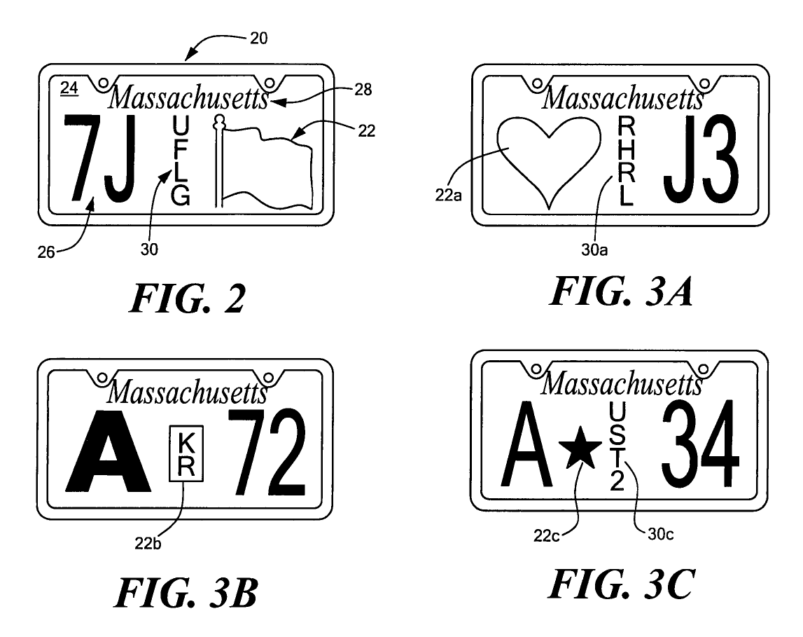

Now imagine the same scenario except that the vehicle bears license plate 20, FIG. 2 in accordance with the subject invention. License plate 20 includes large symbol 22 on face 24 (in this example a solid blue flag) preferably occupying about 20 percent of face 24 so it can be readily recognized by a child. Letter/number combination 26 along with symbol 22 constitute the unique license plate number or code (7J blue flag).

Now, and especially after attendance at the educational component of the subject invention wherein children are taught, inter alia, to identify symbol 22 first, the vehicle second, and the remainder of the license plate next (in this example, the “7J” and the state identification 28), it is likely that at least one child witness will note, at a bare minimum, the blue flag symbol and be able to articulate to authorities that the vehicle in question was a black truck bearing a license plate with a blue flag.

Now, of all the black trucks in the region, only a small percentage will bear a license plate with a blue flag symbol and the possibility of apprehending the suspect greatly increases.

Typically, to meet the distinctiveness requirement, only a small percentage of license plates in a given region (e.g., state) include the blue flag symbol. Other license plates include distinctively colored flags of other colors (e.g., black, blue, or green) and still other plates include other symbols (e.g., trees, butterflies, stars, soccer balls, and the like). And, even geometric shapes such as stars, rectangles, triangles, and the like are possible symbols.

By utilizing many different symbols of many different colors in connection with letters and/or numbers, each license plate can still be unique even for a state with a large number of vehicle registrants.

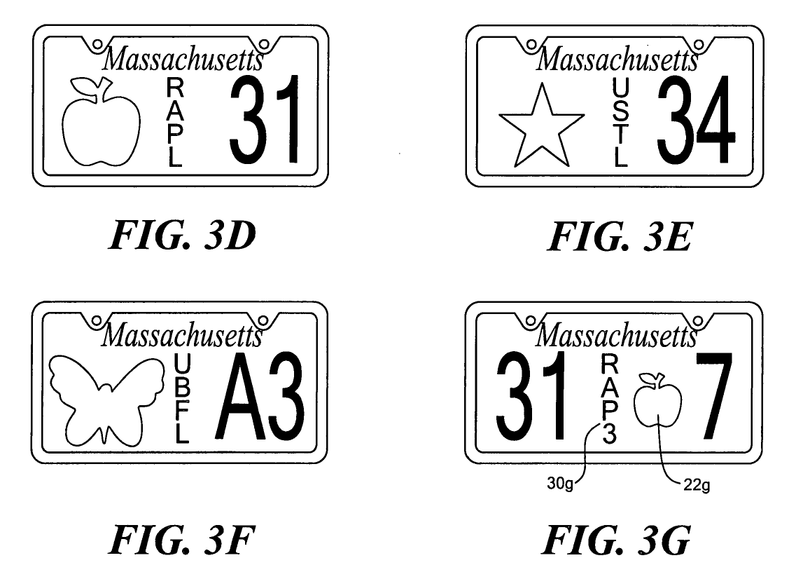

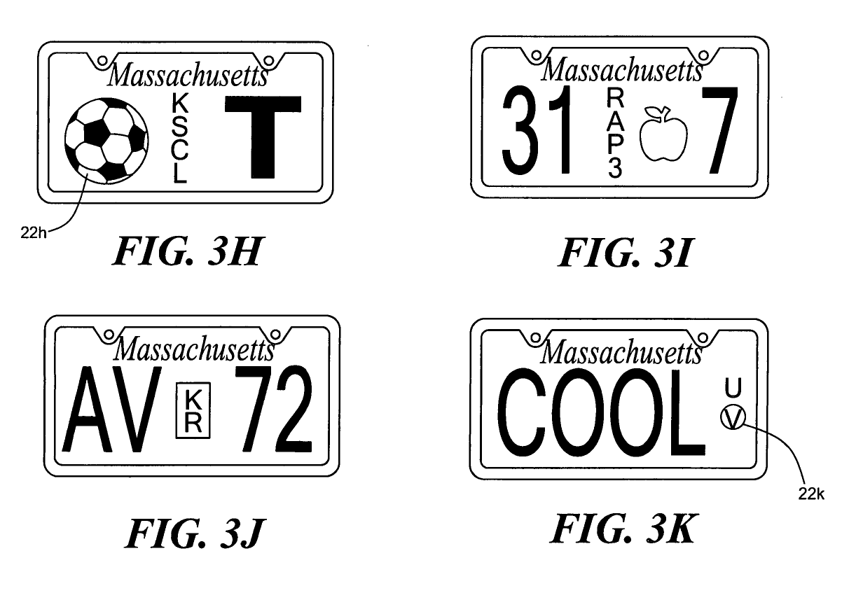

In the preferred embodiment, license plate 20, FIG. 2 also includes cryptogram 30 wherein the “U” is a code for the color of symbol 22 and “FLG” is a mnemonic for the name of the name of symbol 22. Cryptogram 30 may be a part of the license plate number or code or not. Or, as shown in FIG. 3A, cryptogram 30a includes an “R” for red, “HR” for heart symbol 22a and “L” for the position of red heart symbol 22a on the plate.

In some instances, vehicle registrants may be able to select and pay a premium for a given symbol on their license plate, for example a soccer ball 22h, FIG. 3H or other depiction which means something to the registrant. In still other instances, the symbol is a geometric shape such as rectangle symbol 22b, FIG. 3B, a triangle, or circle 22k, FIG. 3K. In other examples, the symbol is symbolic of a region, for example, an outline of a witch for Salem, Mass. or a depiction of a Minuteman for a Lexington, Mass. In still other examples, the symbol could be as simple as an enlarged letter or number which stands out apart from and with respect to the remainder of the license plate number.

The use of a symbol as an easily recognizable portion of the license plate code is applicable to adults as well as children and mnemonic 30, FIG. 2 can be used to aid color blind people to better identify the color of symbol 22 since the “U” portion of mnemonic 30 means blue.

FIGS. 3A-3K show examples of alternate versions of a more readily identifiable license plate in accordance with the subject invention where the symbol on the license plate of FIG. 3A is a red heart 22a in the left zone as denoted by the “L” of cryptogram 30a which also denotes that the symbol 22a is a red heart by the lettering “RHR” also in red. Symbol 22b in FIG. 3B is a rectangle as shown in the middle zone and symbol 22c of FIG. 3C is a blue star in the second position of the left zone as depicted by the number “2” of cryptogram 30c. Symbol 22g of FIG. 3G is a red apple as denoted by cryptogram 30g where in the number 3 thereof denotes that the red apple symbol 22g is in the third position on the license plate. Symbol 22k, FIG. 3K is a circle with the “V” inside depicting that the license plate of FIG. 3K is a vanity plate.

The more that we recognize what we see, the greater the chance is that we can commit it to memory. We all, and especially children, most readily recognize and can recall images, rather than a random series of difficult to see and discern small numbers and letters especially on a moving vehicle. For example, a child knows that a duck goes quack, quack, before they can read or write. Children first learn about living creatures like cats, dogs, birds, and about objects like a ball, or a tree, etc. They then learn about colors and shapes, such as circles and squares, etc. They learn to read last. Therefore, a random series of numbers and letters have even less meaning to children than even to us.

Children would be taught in school about the program and a listing of the active symbols would be on prominent display at the schools, municipal buildings, with police, and sent to all homes, etc. If not recognized from memory or familiarity from the chart, a review of the symbols under adult or police supervision should lead to matching up of the symbol.

Currently, there are 226,646,079 registered vehicles, of which 136,340,945 were automobiles, in the U.S., according to 2001 D.O.T. Statistics. California alone has 28,780,000 registered vehicles of which 17,918,760 were automobiles. Normally only using a series of 4 characters comprised of numbers (9) and letters (26) (with O and 0 being used as one), there are 1,500,625 combinations thus:
35×35×35×35=1,500,625 (1)

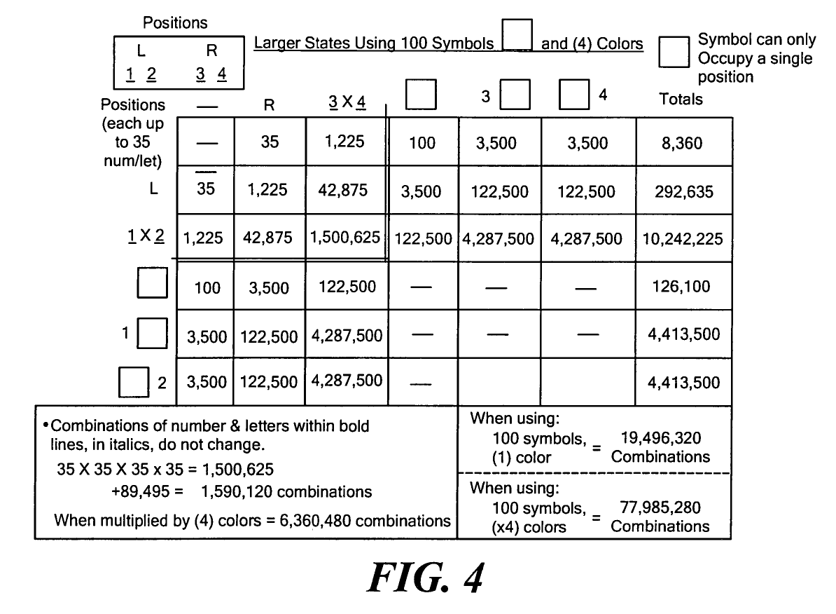

The table of FIG. 4 proves that with even just 100 symbols in four different colors almost 78,000,000 combinations are created. By varying the position of the symbol, adding more symbols, and/or adding another color, the number of symbols required can be reduced. In accordance with the method of the subject invention, it is even possible for vehicles of a certain type in a given state or region, for example black trucks, would never have a license plate bearing the same color symbol.

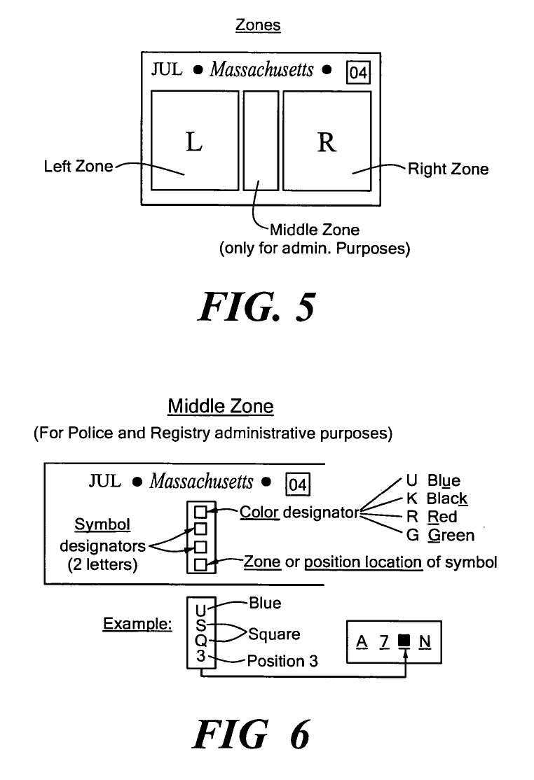

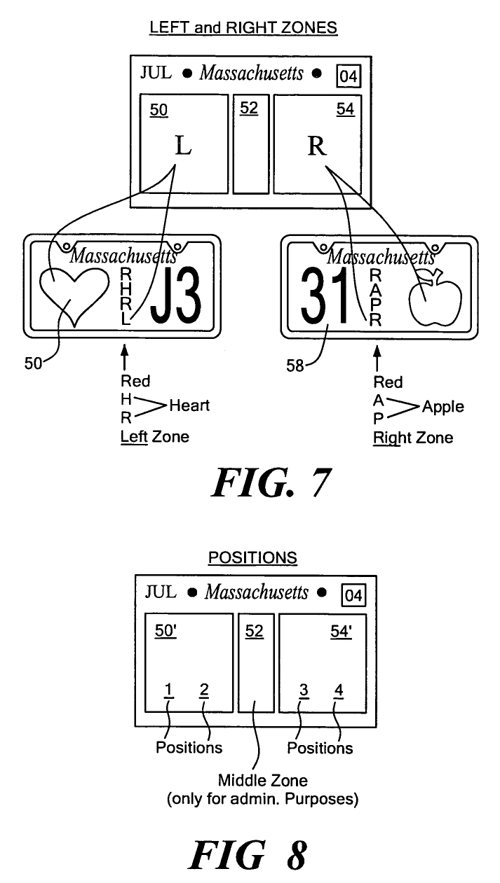

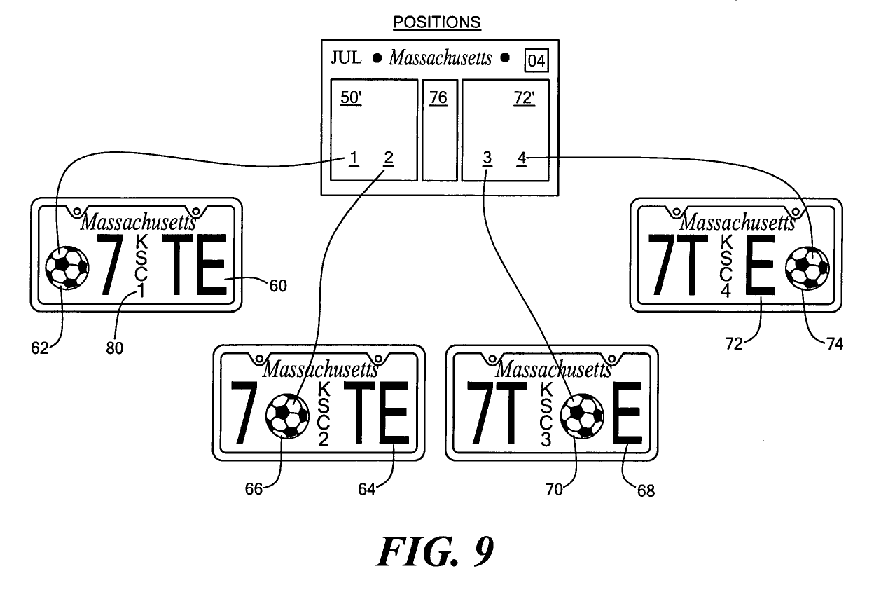

FIG. 5 depicts how a license plate can be divided into a left zone 50, a middle zone 52, and a right zone 54. Middle zone 52 is explained with reference to FIG. 6. Typically, the left and right zones are occupied by the chosen symbol as shown for the license plates 56 and 58, FIG. 7 and the cryptogram occupying middle zone 52 includes an “L” or an “R” for administrative purposes to denote which zone is occupied with the symbol. Alternatively, or in addition, different zones 50′ and 54′, FIG. 8 can include different positions so a license plate will have positions 1 and 2 in left hand zone 50′ and positions 3 and 4 in right hand zone 54′. Again, middle zone 54 is for administrative purposes. Accordingly, in FIG. 9, license plate 60 has a soccer ball symbol 62 in position 1 of left hand zone 50′, license plate 64 has soccer ball symbol 66 in position 2 of left hand zone 50′, license plate 68 has soccer ball symbol 70 in position 3 of right hand zone 72′, and license plate 72 has soccer ball symbol 74 in position 4 of the license plate also in right hand zone 72′. Administrative middle zone 76 includes, for a license plate 60, mnemonic or code or cryptogram 80 which includes the letter “K” for the color black, “SC” for soccer ball, and the number 1 denoting the position of soccer ball symbol 62 in position 1 of left side zone 50′.

In this way, the educational component of the subject invention includes teaching children how to identify the symbol of the license plate first, and then the location of the symbol on the plate, the color of the symbol, the type of vehicle bearing the license plate, and then perhaps the remainder of the license plate number or code last (if possible, given the circumstances).

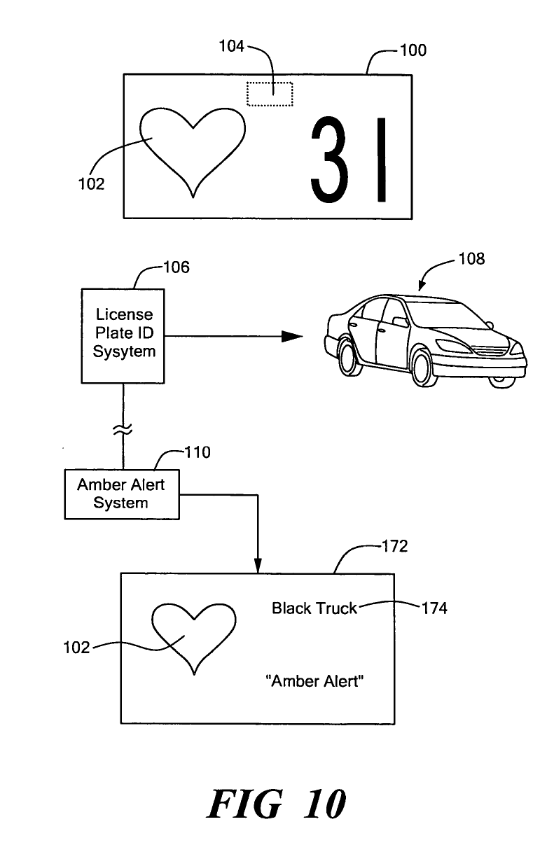

Also in accordance with the subject invention, the more readily identifiable license plate disclosed herein and shown at 100, FIG. 10 including easily recognizable symbol 102 may also include sensor chip 104 (which, alternatively, could be located on the vehicle) and thus used in conjunction with license plate identification system 106 which reads license plate 100 and symbol 102 as shown at 108. This information can be fed automatically to Amber alert system type notification system 110 which includes display 112 depicting, on a free way overpass, for example, an alert so that drivers readily notice the symbol 102 as a red heart and begin looking for all vehicles all black trucks as shown at 114 using, in addition, any other information provided on Amber alert display 112.

As indicated above, it is preferred that the more readily identifiable license plate of the subject invention includes a face with illumination material thereon such as strontium aluminate. This material is used in signage and it is available from Metal Safe Sign International, LTD (Liverpool, UK). Metal Safe Sign International, LTD is in the process of testing and installing signage with photoluminescent properties in railroad tunnels and in the metros of Norway.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims:

1. A more readily identifiable license plate comprising:
a face;
a symbol occupying a large portion of the face so it can be recognized by a child; and
a combination of a letter or letters and/or a number or numbers, wherein the symbol together with the combination of letters and/or numbers constitute a unique license plate number or code.

2. The license plate of claim 1 in which the symbol is in color.

3. The license plate of claim 1 further including a cryptogram on the face of the license plate.

4. The license plate of claim 3 in which the cryptogram indicates the color of the symbol.

5. The license plate of claim 3 in which the cryptogram indicates the type of symbol.

6. The license plate of claim 3 in which the cryptogram indicates the color of the symbol and the type of the symbol.

7. The license plate of claim 3 in which the cryptogram includes a mnemonic.

8. The license plate of claim 7 in which the mnemonic includes letters abbreviating the type of symbol.

9. The license plate of claim 3 in which the cryptogram indicates the position of the symbol.

10. The license plate of claim 1 in which the symbol is a geometric shape.

11. The license plate of claim 1 in which the symbol is a visual depiction of a person, animal, place, or thing.

12. The license plate of claim 1 in which the symbol is a letter.

13. The license plate of claim 1 in which the symbol is representative of the region of registration of the license plate.

14. The license plate of claim 1 in which the symbol is chosen by the registrant.

15. The license plate of claim 1 in which the symbol is solid.

16. The license plate of claim 1 in which the symbol occupies at least 15% of the face of the license plate.

17. The license plate of claim 1 in which the face includes an illumination material.

18. The license plate of claim 1 in which the illumination material includes strontium aluminate.

19. The license plate of claim 1 in which the face is divided into zones.

20. The license plate of claim 19 in which there is a left zone, a middle zone, and a right zone.

21. The license plate of claim 20 in which the symbol occupies the left zone or the right zone.

22. The license plate of claim 20 in which the left zone and the right zones are subdivided into multiple positions.

23. The license plate of claim 22 in which the symbol occupies a single position in a zone.

24. A more readily identifiable license plate comprising:
a face;
a colored symbol occupying a large portion of the face so it can be recognized by a child; and
a cryptogram on the face of the license plate which indicates the type and color of the symbol.

25. The license plate of claim 24 in which the cryptogram includes a mnemonic.

26. The license plate of claim 25 in which the mnemonic includes letters abbreviating the type of symbol.

27. A more readily identifiable license plate comprising:
a face;
a symbol in color occupying a large portion of the face so that can be recognized by a child;
a cryptogram on the face of a license plate which indicates the color of the symbol, the type of the symbol, and the position of the symbol; and
a combination of a letter or letters and/or a number or numbers, wherein the symbol together with the combination of letters and/or numbers constitute a unique license plate number or code.

28. A more readily identifiable license plate comprising:
a face with an illumination material thereon;
a symbol occupying a large portion of the face so that can be recognize by a child; and
a combination of a letter or letters and/or a number or numbers, wherein the symbol together with a combination of letters and/or numbers constitute a unique license plate number or code.

29. A more readily identifiable license plate comprising:
a face divided into a left zone, a middle zone, and a right zone;
a symbol occupying either the left or right zone;
a cryptogram occupying the middle zone which indicates the color, type, and position of the symbol; and
a combination of a letter or letters and/or a number or numbers, wherein the symbol together with the combination of letters and/or numbers constitute a unique license plate number or code.

30. A system for facilitating the apprehension of child abductors, the system comprising:
a plurality of readily identifiable license plates including a symbol as a part of the license plate number or code; and
an educational component for teaching children how to identify the symbol of the license plate first and then the remainder of the license plate number or code.

31. The system of claim 30 in which the educational component teaches children how to identify the location of the symbol on the plate, the color of the symbol, and the type of vehicle bearing the plate.

32. A method for facilitating the apprehension of child abductors, the method comprising:
producing and registering vehicles with more readily identifiable license plates each including a colored symbol as a part of the license plate number or code; and
teaching children to identify the symbol of the license plate first.

33. The method of claim 32 further including the steps of teaching children how to identify the location of the symbol on the plate, the color of the symbol, and the type of vehicle bearing the plate.
